(19) United States
(12) Patent Application Publication
(10) Pub. No.: US 2004/0101789 A1
(43) Pub. Date: May 27, 2004

(54) Reversible multicolor recording medium, and recording method using the same

(76) Inventors: Kenichi Kurihara, Kanagawa (JP); Noriyuki Kishii, Kanagawa (JP); Hisanori Tsuboi, Kanagawa (JP)

Correspondence Address: William E. Vaughan, Bell, Boyd & Lloyd LLC, P.O. Box 1135, Chicago, IL, 60690, US

(21) Appl. No.: 10/636,831

(22) Filed: Aug. 7, 2003

(30) Foreign Application Priority Data
Aug. 19, 2002 (JP) JP2002-238152

(51) Int. Cl. G03C 1/72

(52) U.S. Cl. 430/336; 430/138; 430/350; 430/944; 503/214

(57) ABSTRACT

A reversible multicolor recording medium includes a supporting substrate and a recording layer including reversible thermal coloring compositions having different colors on the supporting substrate. The reversible thermal coloring compositions are included within a separated and independent minute gap structure, and respectively have light-to-heat transforming materials which respectively absorb infrared rays having different wavelength ranges to generate heat.

The present invention relates to a reversible multicolor recording medium for recording image or data, and a recording method using the same.

### BACKGROUND OF THE INVENTION

Recently, the necessity of a rewritable recording technique is strongly recognized from the viewpoint of protecting the environment. In accordance with the progress of computer network technology, communication technology, OA machines, recording media, and memory media, paperless technology is being spread at offices and homes. Recording media onto which information can be recorded and erased reversibly utilizing heat, so-called reversible thermal recording media, are one of display media used as a substitute for printed materials, and, as a variety of prepaid cards, point cards, credit cards, and IC cards spread, the reversible thermal recording media have been practically used in the applications in which the balance or other recorded information is needed to be visible or readable, and further they are being brought into practical use in the applications of copying machines and printers.

The reversible thermal recording medium and a recording method using the same are described in, for example, Unexamined Japanese Patent Application Laid-Open Specification Nos. 54-119377, 55-154198, 63-39377, and 63-41186. These are so-called low-molecular substance dispersion type recording media, that is, recording media having a recording layer comprising an organic low-molecular weight substance dispersed in a resin matrix, and the light scattering on the media is changed by thermal history to make the recording layer an opaque or transparent state. Therefore, these media have drawbacks in that the contrast between an image formed portion and an image unformed portion, namely an image portion and the other portion is unsatisfactory. Accordingly, only media that are improved in the contrast by providing a reflective layer under the recording layer have been put into practical use.

On the other hand, Unexamined Japanese Patent Application Laid-Open Specification Nos. 2-188293, 2-188294, 5-124360, 7-108761, and 7-188294 disclose a recording medium having a recording layer comprising a leuco dye, which is an electron donating color-forming compound, and a developer dispersed in a resin matrix, and a recording method using the same. In these patent documents, as the developer, an amphoteric compound having an acidic group for developing a leuco dye and a basic group for erasing the colored leuco dye, or a phenolic compound having long-chain alkyl is used. The recording medium and recording method utilize coloring of the leuco dye itself, and therefore, the contrast and recognizability are excellent, as compared to those of the low-molecular substance dispersion type recording medium, and they are being widely used.

In the conventional technique disclosed in the above patent documents, only two colors, specifically, the color of the material for the matrix, i.e., color of the primary surface and the color changed by heat can be displayed. However, in recent years, for improving the recognizability and appearance, there are increasingly strong demands of multicolor image display and recording of various data with color identification. For meeting the demands, a number of recording methods have been proposed, in which the above-mentioned conventional technique is applied and a multicolor image is displayed.

Unexamined Japanese Patent Application Laid-Open Specification Nos. 5-62189, 8-80682, and 2000-198275 disclose a recording medium in which layers or particles having different colors are render visible or hidden by a low-molecular substance dispersion type recording layer to achieve multicolor display, and a recording method using the same. However, in the recording medium having such a construction, the recording layer cannot completely hide the colors of the underlying layers and the color of the matrix is seen through, so that a high contrast cannot be obtained.

In Unexamined Japanese Patent Application Laid-Open Specification Nos. 8-58245 and 2000-25338, there are disclosures concerning reversible thermal multicolor recording media using a leuco dye, but these reversible thermal multicolor recording media have repeating units having different hues in the surface, and therefore the area ratio of the individual hues to the actually recorded portion is small. Thus, the recorded image is very dark or has a low contrast.

In Unexamined Japanese Patent Application Laid-Open Specification Nos. 6-305247, 6-328844, 6-79970, 8-164669, 8-300825, 9-52445, 11-138997, 2001-162941, and 2002-59654, there are disclosures concerning reversible thermal multicolor recording media having a construction in which recording layers using leuco dyes having different coloring temperatures, decoloring temperatures, and cooling rates are formed so that they are separated and independent from one another.

However, in reversible thermal multicolor recording media as described in the above patent documents, these reversible thermal multicolor recording media have problems in that temperature control is difficult using a recording heat source, such as a thermal head, and an excellent contrast cannot be obtained, so that an occurrence of fogging cannot be avoided. Further, it is very difficult to control the recording of multicolor, i.e., three colors or more merely by changing the heating temperature using a thermal head or the like and/or the cooling rate after heating.

On the other hand, in Unexamined Japanese Patent Application Laid-Open Specification No. 2001-1645, there is a disclosure concerning a recording method using a reversible thermal multicolor recording medium having a construction in which recording layers using leuco dyes are formed so that they are separated and independent from one another, in which only an arbitrary recording layer is heated and colored by light-to-heat transformation using a laser beam. In this method, only a desired recording layer can be colored by the effect of the wavelength selectivity of the light-to-heat transforming layer, possibly solving the problem of fogging accompanying the conventional reversible multicolor recording media.

However, the light-to-heat transforming layer and the recording layer are individually formed, and therefore the number of the constituent layers is large, causing the production process to be complicated. Further, the method has a problem in that energy generated by the light-to-heat transformation in the laser radiation is not efficiently transferred to the recording layer, so that satisfactory coloring cannot be achieved, thus prolonging the time for recording.

As mentioned above, there are strong demands on the multicolor thermal recording and studies are vigorously conducted, but a practically satisfactory recording medium or recording method has not yet been found.

### SUMMARY OF THE INVENTION

In view of the above problems accompanying the prior art, in the present invention, there is provided a reversible multicolor thermal recording medium, which is advantageous not only in that the medium has stable coloring and decoloring properties and excellent contrast as well as image stability practically satisfactory in our daily life, but also in that the medium is high-speed printable and erasable, and a recording method using the same.

The reversible multicolor recording medium of the present invention comprises a supporting substrate, and a recording layers in which reversible thermal coloring compositions having different colors are sealed within a separated and independent minute gap structure, wherein the plurality of reversible thermal coloring compositions having different colors respectively comprise light-to-heat transforming materials which respectively absorb infrared rays having different wavelength ranges to generate heat.

In the recording method of the reversible multicolor recording medium of the present invention, on a supporting substrate, there is provided a recording layer in which reversible thermal coloring compositions having different colors are sealed within a separated and independent minute gap structure. The plurality of reversible thermal coloring compositions having different colors are formed to be a reversible multicolor recording medium including light-to-heat transforming materials which respectively absorb infrared rays having different wavelength ranges to generate heat. The recording method of the present invention comprises: heating the recording medium so that each of the plurality of recording layers is in a decolored state; in accordance with predetermined image information, irradiating the recording medium with an infrared ray having a wavelength range corresponding to the selected reversible thermal coloring compositions of the recording layer; and allowing the recording layer selected to generate heat so that the recording layer is selectively colored, achieving recording of the image information.

In the recording method of the reversible multicolor recording medium of the present invention, on a supporting substrate, there is provided a recording layer in which reversible thermal coloring compositions having different colors are sealed within a separated and independent minute gap structure. The plurality of reversible thermal coloring compositions having different colors are formed to be a reversible multicolor recording medium including light-to-heat transforming materials which respectively absorb infrared rays having different wavelength ranges to generate heat. The recording method of the present invention comprises: heating the recording medium so that each of the plurality of recording layers is in a colored state; in accordance with predetermined image information, irradiating the recording medium with an infrared ray having a wavelength range corresponding to the selected reversible thermal coloring compositions of the recording layer; and allowing the recording layer selected to generate heat so that the recording layer is selectively decolored, achieving recording of the image information.

In the present invention, there are obtained a reversible multicolor thermal recording medium, which is advantageous not only in that the medium has stable coloring and decoloring properties and excellent contrast as well as image stability practically satisfactory in our daily life, but also in that the medium is high-speed printable and erasable, and a recording method using the same.

In the present invention, there is provided a reversible multicolor recording medium such that radiation of an infrared ray having a selected wavelength selectively allow an arbitrary recording layer to generate heat and reversible conversion of the recording layer between a colored state and a decolored state can be achieved, thus making it possible to record and erase information repeatedly.

Further, the reversible multicolor recording medium of the present invention can simplify the production process, as compared to a reversible multicolor recording medium having a light-to-heat transforming material layer and a recording layer which are independently provided.

In addition, by the method of the present invention, light-to-heat transformation in the recording layer can be efficiently achieved to improve the recording sensitivity. Further, an occurrence of locally heating in the recording layer can be avoided to improve the repetition durability.

Additional features and advantages of the present invention are described in, and will be apparent from, the following Detailed Description of the Invention and the figures.

### BRIEF DESCRIPTION OF THE DRAWINGS

FIG. 1 is a diagrammatic cross-sectional view of one embodiment of a reversible multicolor recording medium of the present invention; and

FIG. 2 is a diagrammatic cross-sectional view of the reversible multicolor recording medium prepared in Comparative Example 1.

### DETAILED DESCRIPTION OF THE INVENTION

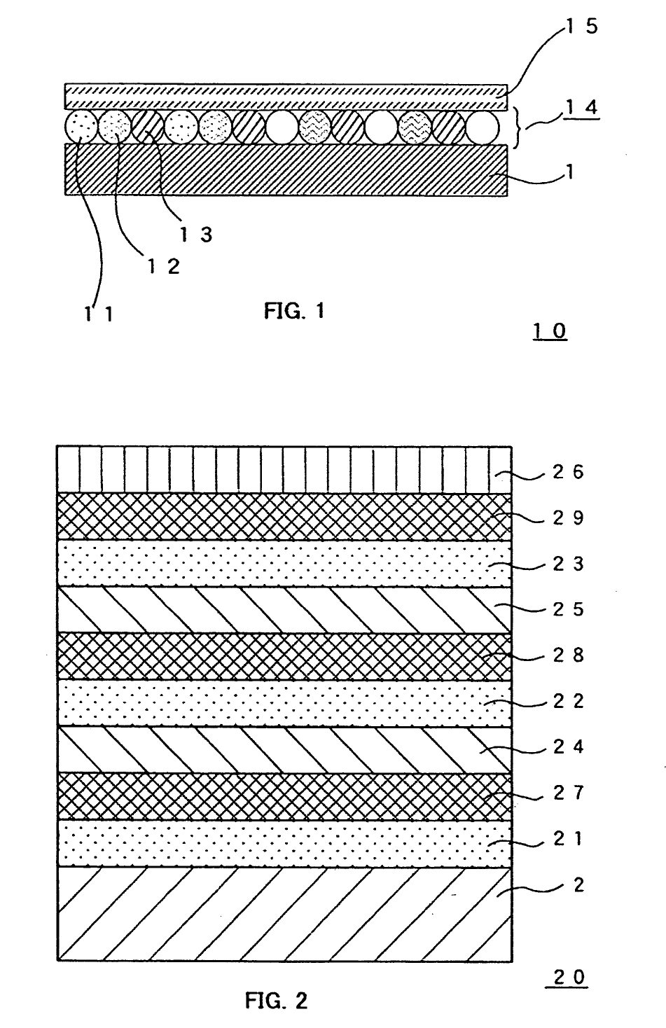

FIG. 1 shows a diagrammatic cross-sectional view of the reversible multicolor recording medium of the present invention wherein a microcapsule is exemplified as a minute gap structure. A reversible multicolor recording medium 10 is formed with a recording layer 14 in which microcapsules are arranged in a plane, where a first coloring composition 11, a second coloring composition 12, and a third coloring composition 13 are respectively sealed within the microcapsules. A protecting layer 15 is then formed on the recording layer 14.

As the supporting substrate 1, any conventionally known materials can be used as long as they have excellent heat resistance and excellent planar dimensional stability. For example, it can be appropriately selected from polymer materials, such as polyester and rigid vinyl chloride; glass materials; metallic materials, such as stainless steel; and other materials, such as paper. In applications other than the application requiring transparency, e.g., overhead projector, for improving the recognizability of the information recorded on the reversible multicolor recording medium 10 finally obtained, it is preferred that the supporting substrate 1 is formed from a material having a white or metallic color and having a higher reflectance with respect to visible lights.

The first to third coloring compositions 11 to 13 are formed using a material which can be recorded stably and repeatedly and which can control the decolored state and colored state. Particularly, the first to third coloring compositions 11 to 13 respectively comprise light-to-heat transforming materials which respectively absorb infrared rays having different wavelengths (λ₁, λ₂, and λ₃ in FIG. 1) to generate heat.

These first to third coloring compositions 11 to 13 are individually formed by application of, for example, a leuco dye, a developer, and the light-to-heat transforming material dispersed in a resin matrix as requested. The first to third coloring compositions 11 to 13 are formed using respectively predetermined leuco dyes according to the desired coloring colors and, for example, when the first to third coloring compositions 11 to 13 are colored, respectively, three primary colors, a full color image can be formed on the reversible multicolor recording medium 10 as a whole.

As the leuco dye, existing leuco dyes for thermal recording paper and the like can be used. As the developer, organic acids having a long-chain alkyl group conventionally used as developers (described in, for example, Unexamined Japanese Patent Application Laid-Open Specification Nos. 5-124360, 7-108761, 7-188294, 2001-105733, and 2001-113829) can be used.

The first to third coloring compositions 11 to 13 respectively contain infrared absorbing dyes having absorptions respectively in different wavelength ranges. In the reversible multicolor recording medium 10 shown in FIG. 1, the first coloring composition 11 contains a light-to-heat transforming material which absorbs an infrared ray having a wavelength λ₁ to generate heat, the second coloring composition 12 contains a light-to-heat transforming material which absorbs an infrared ray having a wavelength λ₂ to generate heat, and the third coloring composition 13 contains a light-to-heat transforming material which absorbs an infrared ray having a wavelength λ₃ to generate heat.

As the light-to-heat transforming materials contained in the first to third coloring compositions 11 to 13, there can be used phthalocyanine dyes, cyanine dyes, metal complex dyes, and diimmonium dyes, which are generally used as infrared absorbing dyes having almost no absorption in a visible light range. Further, for allowing only an arbitrary light-to-heat transforming material to generate heat, it is preferred to select a combination of the materials so that the absorption bands of the light-to-heat transforming materials are individually narrow and they do not overlap.

Examples of resins constituting the first to third coloring compositions 11 to 13 include polyvinyl chloride, polyvinyl acetate, vinyl chloride-vinyl acetate copolymers, ethyl cellulose, polystyrene, styrene copolymers, phenoxy resins, polyester, aromatic polyester, polyurethane, polycarbonate, polyacrylate, polymethacrylate, acrylic acid copolymers, maleic acid polymers, polyvinyl alcohol, modified polyvinyl alcohol, hydroxyethyl cellulose, carboxymethyl cellulose, and starch. If desired, an additive, such as an ultraviolet absorber, may be added to the resin. Further, instead of above mentioned resin, it is possible to seal the leuco dye, the developer, and infrared absorbing dye within the minute gap structure.

In the present invention, the minute gap structure as a partition, it is not limited to a microcapsule, and other material such as a capillary or a cell that forms the minute gap structure to seal the disperse medium may be used. Further, it is possible to improve the resolution of the display apparatus by making finer the gap structured section. In addition, the minute gap structure such as microcapsules may be dispersed in a predetermined binder, and in this case, the binder such as waterborne binder, solvent binder, emulsion binder or the like may be used.

Further, the recording layers 14 can be formed by applying on the supporting substrate 1 a coating material prepared by dispersing in the resin the minute gap structure. It is desired that the recording layer 14 is formed so that the individual thickness becomes about 1 to 20 μm, further preferably about 3 to 15 μm. When the thickness of the recording layer 14 is too small, a satisfactory coloring density cannot be obtained. On the other hand, when the thickness is too large, the heat capacity of the recording layer 14 is increased, so that the coloring properties or decoloring properties may deteriorate.

The protecting layer 15 can be formed using a conventionally known ultraviolet curing resin or thermosetting resin, supports the recording layer 14 formed on the supporting substrate 1, has a light transmittance state so that the coloring composition within the minute gap structure from outside, and has a mechanical strength necessary for implementation. The film thickness of the protecting layer 15 is desirably a thickness of 0.1 to 20 μm, further desirably about 0.5 to 5 μm.

Hereinafter, a fabrication method of the reversible multicolor recording medium 10 of the present invention is explained, and in the following embodiment, the developer-, and infrared absorbing dye-based core material is covered with shell material such as polymer, and thus formed to be microcapsule form as an example, but the present invention is not limited to this example.

As a fabrication method for a microcapsule, following microencapsulation technologies such as a phase separation method in which highly concentrated phase is separated around core material made of a disperse medium dispersed in polymer solution, orifice method in which polymer is cured around core material within polymer solution by curing test drug for polymer and the like, in-situ polymerization method in which surfaces of core material is covered with a polymer by supplying monomer or polymerization catalyst from inner phase or outer phase of emulsion where core material is dispersed, and a surface polymerization method in which monomer is supplied from both inner phase and outer phase of emulsion where core material is dispersed are suitable, but the present invention is not limited to these.

Particularly, it is able to fabricate microcapsules having uniform particle size, and uniform dispersion of coloring particles by using the in-situ polymerization method or the phase separation method. The polymerization monomer used herein are suitably, for example, acrylic ester, methacrylic ester, styrene and its derivative, isocyanate, various kind of amine, and epoxy group compound. As resin to be used for microcapsule, there are generally used resin such as acrylic resin, methacrylic resin, polystyrene, polyester resin, polyurethane resin, polyurea resin, polyamide resin, epoxy resin, and natural resin. These are possible to be used by themselves or by mixing two or more of them.

These recording layer and protecting layer are able to be formed by a forming method such as, for example, a well-known printing system such as an offset printing method, a gravure printing method and a silkscreen printing method, and a coating system such as a roll coating method, and a knife-edge method. Additional forming methods include a transfer-printing system by a transfer sheet having a transfer layer including the above-mentioned microcapsules, an inkjet system for spraying to a substrate an ink including the above-mentioned microcapsules, and a system in which solution including the above-mentioned microcapsules is packed between the supporting substrate and the protecting layer. The above-mentioned systems may be selected depending on the usage of the fabricating information recording medium, and amount thereof.

Next, the principles of the multicolor recording using the reversible multicolor recording medium 10 shown in FIG. 1 are described. First, the first principle of the multicolor recording is described. The whole surface of the reversible multicolor recording medium 10 shown in FIG. 1 is heated to a temperature at which the individual recording layers are decolored, for example, about 120° C., so that the first to third coloring compositions 11 to 13 are preliminarily in a decolored state. That is, in this instance, the color of the supporting substrate 1 is visible.

Then, an arbitrary portion of the reversible multicolor recording medium 10 is irradiated with an infrared ray having arbitrarily selected wavelength and power using, e.g., a semiconductor laser. For example, when coloring the first coloring composition 11, the medium is irradiated with an infrared ray having a wavelength λ₁ at energy such that the first coloring composition 11 reaches its coloring temperature to allow the light-to-heat transforming material to generate heat, and the electron donating color-forming compound and the electron accepting developer undergo a coloring reaction, so that the irradiated portion is colored.

When coloring the second coloring composition 12 and the third coloring composition 13, the medium is similarly irradiated with infrared rays having wavelengths λ₂, λ₃ at energy such that the second coloring composition 12 and the third coloring composition 13 reach the respective coloring temperatures to allow the individual light-to-heat transforming materials to generate heat, so that the irradiated portions can be colored. Thus, it is possible to color an arbitrary portion of the reversible multicolor recording medium 10, enabling full color image formation and various information recording.

In addition, the thus colored recording layer is further irradiated with an infrared ray having an arbitrary wavelength at energy such that the first to third coloring composition 11 to 13 reach the respective decoloring temperature to allow the individual light-to-heat transforming material to generate heat, and the electron donating color-forming compound and the electron accepting developer undergo a color erasing reaction, so that the recording layer can be decolored.

Further, when part of the reversible multicolor recording medium 10 is colored as described above, whole of the reversible multicolor recording medium 10 is uniformly heated to a temperature at which all the coloring compositions are decolored, for example, 120° C., so that the recorded information or image can be erased, and a sequence of the above operations is repeated to make it possible to achieve recording repeatedly.

Next, the second principle of the multicolor recording is described. The whole surface of the reversible multicolor recording medium 10 shown in FIG. 1 is heated to a high temperature at which the individual coloring compositions are colored, for example, about 200° C., and then cooled so that each of the first to third coloring compositions 11 to 13 is preliminarily in a colored state.

Then, a desired portion of the reversible multicolor recording medium 10 is irradiated with an infrared ray having arbitrarily selected wavelength and power using, e.g., a semiconductor laser. For example, when decoloring the first coloring composition 11, the medium is irradiated with an infrared ray having a wavelength λ₁ at energy such that the first coloring composition 11 is decolored to allow the light-to-heat transforming material to generate heat, so that the coloring composition 11 is in a decolored state. When decoloring the second coloring composition 12 and the third coloring composition 13, the medium is similarly irradiated with infrared rays having wavelengths λ₂, λ₃ at energy such that the second coloring composition 12 and the third coloring composition 13 reach the respective decoloring temperatures to allow the individual light-to-heat transforming materials to generate heat, so that the irradiated portions can be decolored. Thus, it is possible to decolor an arbitrary portion of the reversible multicolor recording medium 10, enabling full color image formation and various information recording.

In addition, the thus decolored recording layer is further irradiated with an infrared ray having an arbitrary wavelength at energy such that the first to third coloring compositions 11 to 13 reach the respective coloring temperature to allow the individual light-to-heat transforming material to generate heat, and the electron donating color-forming compound and the electron accepting developer undergo a coloring reaction, so that the recording layer can be colored.

Further, when part of the reversible multicolor recording medium 10 is decolored as described above, whole of the reversible multicolor recording medium 10 is uniformly heated to a temperature at which all the recording layers are colored, for example, 200° C. and then cooled, so that the recorded information or image can be erased, and a sequence of the above operations is repeated to make it possible to achieve recording repeatedly.

A recording method for the reversible multicolor recording medium 10 of the present invention is appropriately selected from the above-described recording methods depending on the properties of the recording layers 14 and the performance of the recording light source. For example, the recording layer 14 may be formed either as a so-called positive layer which is colored at a high temperature and decolored at a temperature lower than that temperature or as a so-called negative layer which is decolored at a high temperature and colored at a temperature lower than that temperature (see, for example, Unexamined Japanese Patent Application Laid-Open Specification No. 8-197853).

Next, the reversible multicolor recording medium of the present invention will be described in more detail with reference to the following Examples and Comparative Examples, which should not be construed as limiting the reversible multicolor recording medium of the present invention.

### EXAMPLE 1

In this Example, a recording layer 14 having a first coloring composition 11, a second coloring composition 12, and a third coloring composition 13 on a supporting substrate 1 is provided, and a recording medium 10 is fabricated by forming a protecting layer 15 on the recording layer 14.

### Microcapsule A

At first, a composition of the coloring composition to be included in the microcapsule A was determined as follows;

Leuco dye (Green DCF; manufactured and sold by HOGOGAYA CHEMICALS Inc.): I Part by weight

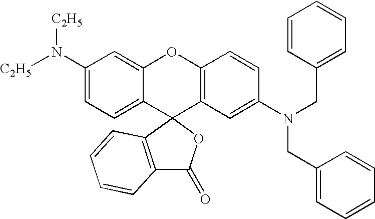

Developer (substance below): 4 Parts by weight

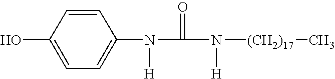

Cyanine infrared absorbing dye: 0.10 Part by weight

(YKR-2081; manufactured and sold by YAMAMOTO CHEMICALS Inc.; absorption wavelength peak in the recording layer: 910 nm)

A microcapsule in which above mentioned coloring composition is sealed and having mean particle diameter of 8 μm is defined as the microcapsule A.

### Microcapsule B

A composition of the coloring composition to be included in the microcapsule B was determined as follows;

Leuco dye (H-3035; manufactured and sold by YAMADA CHEMICAL CO., LTD.): 1 Part by weight

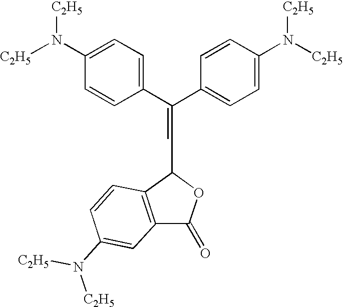

Developer (substance below): 4 Parts by weight

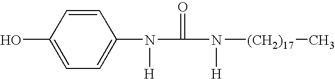

Cyanine infrared absorbing dye: 0.08 Part by weight (YKR-2900; manufactured and sold by YAMAMOTO KASEI Co., Ltd.; absorption wavelength peak in the recording layer: 830 nm) A microcapsule in which above mentioned coloring composition is sealed and having mean particle diameter of 8 Em is defined as the microcapsule B.

### Microcapsule C

A composition of the coloring composition to be included in the microcapsule C was determined as follows;

Leuco dye (Red DCF; manufactured and sold by HOGOGAYA CHEMICALS Inc.): 2 Parts by weight

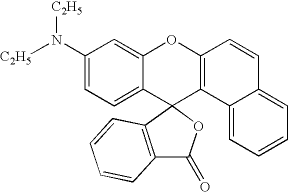

Developer (substance below): 4 Parts by weight

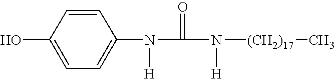

Cyanine infrared absorbing dye: 0.08 Part by weight (CY-10; manufactured and sold by NIHON KAYAKU Co., Ltd.; absorption wavelength peak in the recording layer: 790 nm)

A microcapsule in which above mentioned coloring composition is sealed and having mean particle diameter of 8 μm is defined as the microcapsule C.

The reversible multicolor recording medium of the present invention was obtained by forming a recording layer by application of a coating liquid which was fabricated by uniformly dispersing the above mentioned microcapsules A, B, and C in a polyvinyl alcohol solution on a white polyethylene terephthalate (PET) substrate having 1 mm in thickness, and further by forming a protecting layer made of acrylic resin and having 3 μm in thickness. The thus prepared reversible multicolor recording medium was uniformly heated using a ceramic bar heated to 120° so that the first and second coloring compositions 11, 12 were in a decolored state, and then used as a sample.

### EXAMPLE 2

The reversible multicolor recording medium prepared in Example 1 was heated using a ceramic bar heated to 180° C. and then cooled so that each of the first coloring composition 11 and the second coloring composition 12 was preliminarily colored, and then used as a sample.

### COMPARATIVE EXAMPLE 1

In this example, as described in Unexamined Japanese Patent Application Laid-Open Specification No. 2001-1645, a recording medium where light-to-heat transforming layer and a recording layer are stacked is fabricated. FIG. 2 shows a schematic sectional view of the reversible multicolor recording medium of the present Comparative Example 1.

As the supporting substrate 2, a white polyethylene terephthalate substrate having a thickness of 1 mm was prepared. Next as the first recording layer 21, the composition shown below was applied onto the supporting substrate 2 by means of a wire bar, and dried by heating at 110° C. for 5 minutes to form a recording layer having a thickness of 6 μm and being capable of being colored green.

### Composition

Leuco dye (Green DCF; manufactured and sold by HODOGAYA CHEMICAL CO., LTD.): 1 Part by weight

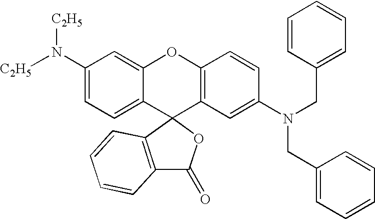

Developer (substance below): 4 Parts by weight

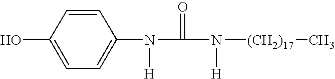

Vinyl chloride-vinyl acetate copolymer: 10 Parts by weight (vinyl chloride: 90%; vinyl acetate: 10%; M.W.: 115,000)

Tetrahydrofuran (THF): 140 Parts by weight

An acetone solution of 0.5 wt % of Cyanine infrared absorbing dye (YKR-2081; manufactured and sold by YAMAMOTO CHEMICALS Inc.) was applied onto the above-formed first recording layer 21 by spin coating to form a light-to-heat transforming layer 27 having an absorbance at a wavelength of 915 run was 1.0.

Further, on the thus formed first light-to-heat transforming layer 27, an aqueous solution of polyvinyl alcohol is applied and then dried to form a heat insulating layer 24 having a thickness of 20 μm. As the second recording layer 22, the composition shown below was applied onto the heat insulating layer 24 by means of a wire bar, and dried by heating at 110° C. for 5 minutes to form a layer having a thickness of 6 μm and being capable of being colored cyan.

### Composition

Leuco dye (H-3035; manufactured and sold by Yamada Chemical Co., Ltd.): 1 Part by weight

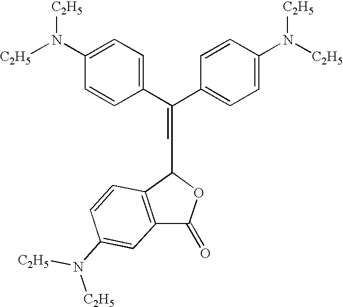

Developer (substance below): 4 Parts by weight

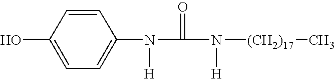

Vinyl chloride-vinyl acetate copolymer: 10 Parts by weight (vinyl chloride: 90%; vinyl acetate: 10%; M.W.: 115,000)

Tetrahydrofuran (THF): 140 Parts by weight

An acetone solution of 0.3 wt % of Cyanine infrared absorbing dye (YKR-2900; manufactured and sold by YAMAMOTO CHEMICALS Inc.) was applied onto the above-formed second recording layer 22 by spin coating-to form a light-to-heat transforming layer 28 having an absorbance at a wavelength of 830 nm was 1.0. Further, on the thus formed second light-to-heat transforming layer 28, an aqueous solution of polyvinyl alcohol is applied and then dried to form a heat insulating layer 25 having a thickness of 20 μm. As the third recording layer 23, the composition shown below was applied onto the heat insulating layer 25 by means of a wire bar, and dried by heating at 110 μC for 5 minutes to form a layer having a thickness of 6 μm and being capable of being colored magenta.

### Composition

Leuco dye (Red DCF; manufactured and sold by HODOGAYA CHEMICAL CO., LTD.): 2 Parts by weight

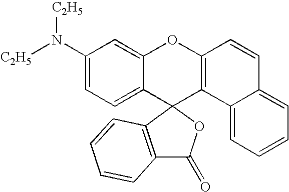

Developer (substance below): 4 Parts by weight

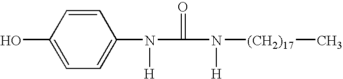

Vinyl chloride-vinyl acetate copolymer: 10 Parts by weight (vinyl chloride: 90%; vinyl acetate: 10%; M.W.: 115,000)

Tetrahydrofuran (THF): 140 Parts by weight

An acetone solution of 0.3 wt % of Cyanine infrared absorbing dye (CY-10; manufactured and sold by NIHON KAYAKU Inc.) was applied onto the above-formed third recording layer 23 by spin coating to form a light-to-heat transforming layer 29 having an absorbance at a wavelength of 785 nm was 1.0. A protecting layer 26 having a thickness of about 2 μm was formed on the third coloring composition 13 using an ultraviolet curing resin to prepare a desired reversible multicolor recording medium. The thus prepared reversible multicolor recording medium was uniformly heated using a ceramic bar heated to 120° C. so that the first, second, and third coloring compositions 11, 12, 13 were in a decolored state, and then used as a sample.

The method for evaluating the reversible multicolor recording medium and the results of evaluation are described below.

### Measurement of Reflection Density

An arbitrary position of the reversible multicolor recording medium as a sample was irradiated with semiconductor lasers having three different wavelengths, i.e., 785 nm, 830 nm, and 915 nm and having a power of 70 mW and a spot diameter of 80 μm while scanning the lasers at speeds of 300 mm/sec and 500 mm/sec to record a line at 20 μm interval to be a solid image. With respect to the recorded sample, a reflectance was measured by means of an autographic spectrophotometer having an integrating sphere to determine a reflection density (reflectance) at a peak wavelength. Respective peak wavelength upon irradiating lasers of 785 nm, 830 nm, and 915 nm in wavelength are 600 nm, 660 nm, and 530 nm.

### Evaluation of Repetition Properties

Lines were recorded on a desired position of the reversible multicolor recording medium as a sample using semiconductor lasers having wavelengths of 785 run, 830 nm, and 915 nm and having a power of 70 mW and a spot diameter of 80 μm under conditions such that the scanning speed was 300 mm/s, and then the lines were erased using a ceramic bar at 120° C. This test operation was repeated 100 times with respect to the same portion of each medium. The recorded portion was examined through a microscope to evaluate deterioration of the sample.

### Evaluation of Erasing Properties

Lines were recorded at 20 μm interval to form a solid image on a desired position of the reversible multicolor recording medium as a sample using semiconductor lasers having wavelengths of 785 nm, 830 nm, and 915 nm and having a power of 70 mW and a spot diameter of 80 μm under conditions such that the scanning speed was 300 mm/s. After that, the sample was irradiated by lasers having wavelengths of 785 nm, 830 nm, and 915 nm and having a power of 70 mW and a spot diameter of 250 μm under conditions such that the scanning speed was 200 mm/s to erase the recorded portion. With respect to the erased sample, a reflectance was measured by means of an autographic spectrophotometer having an integrating sphere to determine a reflection density (reflectance) at a peak wavelength.

### Evaluation Results

With respect to each of the recording media in Example 1, and Comparative Example 1, writing solid image was conducted using laser beams having wavelengths of 915 nm, 830 nm, and 785 nm and having a power of 70 mW, and the obtained reflection density (reflectance) at a peak wavelength is shown in Table 1 below.

It is found that the solid image recorded on the medium in Example 1 has a more than equal reflection density than that of the solid image recorded on the medium in Comparative Example 1, indicating that in the present embodiment, the lights radiated were efficiently transformed to heat to color the recording layers. In other words, in the recording medium of the present invention, by virtue of employing the construction in which the light-to-heat transforming material is uniformly dispersed in the recording layer, it was able to obtain the recording medium having improved recording sensitivity and the reflection density.

With respect to each of the recording media in Example 1 and Comparative Example 1, a solid image was recorded using laser beams having wavelengths of 915 nm, 830 nm, and 785 nm, and then the recorded image was irradiated with laser beams having wavelengths of 785 nm, 830 nm, and 915 nm and having a power of 70 mW and a spot diameter of 250 μm while scanning the lasers at a speed of 200 mm/sec to erase the recorded portion, and the reflection density thereof are shown in Table 1 below.

In the medium in Example 1, after the 100-time repetition of a cycle of the recording and erasing, no deterioration was observed in the recording layer. However, in the medium in Comparative Example 1, after the 100-time repetition of a cycle of the recording and erasing, deterioration was found in the center portion of the recorded lines in the recording layer. The reason for this is that, in the medium in Comparative Example 1, the light-to-heat transforming layer having a smaller thickness transforms a strong laser to heat and the temperature of this layer locally rises, causing the recording layer to locally deteriorate. Accordingly, in Example 1 according to the method of the present invention, it is thought that by virtue of having the construction in which the light-to-heat transforming material is uniformly dispersed in the recording layer, an occurrence of locally heating is prevented, improving the durability of the recording layer.

TABLE 1

| | | | | Coloring | | |
|---|---|---|---|---|---|---|
| | Laser | Spot | Scan | composition | | |
| | wavelength | diameter | speed | to be | Reflection | Repeated |
| Medium | (nm) | (μm) | (mm/s) | recorded | density | Measurement |
| Exp. 1 | 915 | 80 | 300 | First | 1.1 | OK |
| | | | | composition | | |
| Exp. 1 | 830 | 80 | 300 | Second | 1.25 | OK |
| | | | | composition | | |
| Exp. 1 | 785 | 80 | 300 | Third | 1.05 | ok |
| | | | | composition | | |
| Exp. 1 | 915 | 150 | 300 | First | 0.95 | OK |
| | | | | composition | | |
| Exp. 1 | 830 | 150 | 300 | Second | 1.1 | OK |
| | | | | composition | | |
| Exp. 1 | 785 | 150 | 300 | Third | 0.85 | OK |
| | | | | composition | | |
| Exp. 1 | 915 | 80 | 500 | First | 0.9 | OK |
| | | | | composition | | |
| Exp. 1 | 830 | 80 | 500 | Second | 10.5 | OK |
| | | | | composition | | |
| Exp. 1 | 785 | 80 | 500 | Third | 0.8 | OK |
| | | | | composition | | |
| Comp. | 915 | 80 | 300 | First | 1 | NG |
| Exp. 1 | | | | composition | | |
| Comp. | 830 | 80 | 300 | Second | 1.1 | NG |
| Exp. 1 | | | | composition | | |
| Comp. | 785 | 80 | 300 | Third | 1 | NG |
| Exp. 1 | | | | composition | | |
| Comp. | 915 | 150 | 300 | First | 0.9 | OK |
| Exp. 1 | | | | composition | | |
| Comp. | 830 | 150 | 300 | Second | 1 | OK |
| Exp. 1 | | | | composition | | |
| Comp. | 785 | 150 | 300 | Third | 0.95 | OK |
| Exp. 1 | | | | composition | | |
| Comp. | 915 | 80 | 500 | First | 0.8 | NG |
| Exp. 1 | | | | composition | | |
| Comp. | 830 | 80 | 500 | Second | 0.9 | NG |
| Exp. 1 | | | | composition | | |
| Comp. | 785 | 80 | 500 | Third | 0.8 | NG |
| Exp. 1 | | | | composition | | |

With respect to each of the recording media in Example 1 and Comparative Example 1, a solid image was recorded using laser beams having wavelengths of 915 nm, 830 nm, and 785 nm, and then the recorded image was irradiated with laser beams having wavelengths of 785 nm, 830 nm, and 915 nm and having a power of 70 mW and a spot diameter of 200 μm while scanning the lasers at a speed of 200 mm/sec to erase the recorded portion, and the reflection density thereof are shown in Table 2 below.

It is found that the recording medium in Example 1 has a reflection density of the erased portion of 0.02 or less at each wavelength and is in an almost colorless state, whereas, the medium in Comparative Example 1 has a reflection density of the erased portion higher than that in Example 1, indicating that the erasing is unsatisfactory in Comparative Example 1. The reason for this is as follows. The recording medium in Example 2 has a construction such that the light-to-heat transforming material is uniformly dispersed in the recording layer, and therefore heat transfer in the recording layer is uniform, so that the recorded portion can be efficiently erased. By contrast, the medium in Comparative Example 1 has a light-to-heat transforming layer and a recording layer which are independently provided, and hence a heat gradient is caused in the recording layer and a portion remaining colored is caused or the recording layer locally reaches the coloring temperature and satisfactory decoloring cannot be achieved, so that the reflection density becomes higher.

Further, in the reversible multicolor recording medium of the present invention having the construction in which the light-to-heat transforming material is uniformly dispersed in the recording layer, satisfactory decoloring properties can be obtained.

Therefore, the reversible multicolor recording media prepared in Example 2 is heated using a ceramic bar heated to 180° C. and then cooled so that the medium is preliminarily in a colored sate, and then the recorded portion is erased by irradiation of laser beams having wavelengths of 915 nm, 830 nm, and 785 nm, so that a multicolor recorded image can be obtained. The image obtained exhibited the coloring properties and contrast as well as precision equivalent to those of the multicolor recorded images in Example 1, which was first erased and then recorded.

TABLE 2

| | | | | Coloring | |
|---|---|---|---|---|---|
| | Laser | Spot | Scanning | composition | |
| | wavelength | diameter | speed | to be | Reflection |
| Medium | (nm) | (μm) | (mm/s) | recorded | density |
| Exp. 1 | 830 | 250 | 200 | First | 0.02 |
| | | | | composition | |
| Exp. 1 | 785 | 250 | 200 | Second | 0.02 |
| | | | | composition | |
| Exp. 3 | 915 | 250 | 200 | Third | 0.01 |
| | | | | composition | |
| Comp. | 915 | 250 | 200 | First | 0.05 |
| Exp. 1 | | | | composition | |
| Comp. | 830 | 250 | 200 | Second | 0.1 |
| Exp. 1 | | | | composition | |
| Comp. | 785 | 250 | 200 | Third | 0.15 |
| Ex. 1 | | | | composition | |

As mentioned above, the reversible multicolor recording medium of the present invention has a recording layer in which reversible thermal coloring compounds are sealed within a separated and independent minute gap structure on a supporting substrate. The reversible multicolor recording medium including a plurality of light-to-heat transforming materials of the type having different colors which respectively absorb infrared rays having different wavelength ranges to generate heat are uniformly dispersed, respectively, in reversible thermal coloring compositions, and thus it is advantageous not only in that the medium has stable coloring and decoloring properties and excellent contrast as well as image stability practically satisfactory in our daily life, but also in that the medium is high-speed printable and erasable.

Further, in the reversible multicolor recording medium of the present invention, it is able to form the recording layer by applying the minute gap structure including coloring composition on the supporting substrate, so that it is possible to simplify the fabrication process than stacked type and is advantageous in aspect of cost.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A reversible multicolor recording medium comprising:
a supporting substrate; and
a recording layer including reversible thermal coloring compositions having different colors on said supporting substrate, said reversible thermal coloring compositions respectively having light-to-heat transforming materials which respectively absorb infrared rays having different wavelength ranges to generate heat;
wherein said reversible thermal coloring compositions are included within a separated and independent minute gap structure.

2. The reversible multicolor recording medium according to claim 1, wherein a protecting layer is formed on an uppermost surface of the said recording medium.

3. The reversible multicolor recording medium according to claim 1, wherein the reversible thermal coloring compositions contains a color-forming compound having electron donating properties and a developer having electron accepting properties, and said color-forming compound and said developer undergo a reversible reaction to reversibly change the recording layer between a colored state and a decolored state.

4. A recording method using a reversible multicolor recording medium including a supporting substrate, and a recording layer including reversible thermal coloring compositions having different colors on said supporting substrate, said reversible thermal coloring compositions respectively having light-to-heat transforming materials which respectively absorb infrared rays having different wavelength ranges to generate heat, wherein said reversible thermal coloring compositions are included within a separated and independent minute gap structure, said recording method comprising:
heating said recording layer so that each of said plurality of recording layers is in a decolored state;
irradiating said reversible thermal coloring compositions with an infrared ray having a wavelength range corresponding to the reversible thermal coloring compositions in accordance with predetermined image information; and
recording said image information by making the recording layer generate heat and selectively coloring the recording layer.

5. A recording method using a reversible multicolor recording medium including a supporting substrate, and a recording layer including reversible thermal coloring compositions having different colors on said supporting substrate, said reversible thermal coloring compositions respectively having light-to-heat transforming materials which respectively absorb infrared rays having different wavelength ranges to generate heat, wherein said reversible thermal coloring compositions are included within a separated and independent minute gap structure, said recording method comprising:
heating said recording layer so that each of said plurality of recording layers is in a colored state;
irradiating said reversible thermal coloring compositions with an infrared ray having a wavelength range corresponding to the reversible thermal coloring compositions in accordance with predetermined image information; and
recording said image information by making the recording layer generate heat and selectively decoloring the recording layer.

6. The reversible multicolor recording medium according to claim 2, wherein the reversible thermal coloring compositions contains a color-forming compound having electron donating properties and a developer having electron accepting properties, and said color-forming compound and said developer undergo a reversible reaction to reversibly change the recording layer between a colored state and a decolored state.
